(19) United States
(12) Patent Application Publication
(10) Pub. No.: US 2026/0087038 A1
(43) Pub. Date: Mar. 26, 2026

(54) METHOD AND SYSTEM FOR GENERATING ANALYTICS FROM INTERACTION DATA USING REVERSE RETRIEVAL-AUGMENTED GENERATION

(71) Applicant: Verint Americas Inc., Alpharetta, GA (US)

(72) Inventors: Dror Daniel ZIV, Denver, CO (US); Roni RAVUNA, Tel-Aviv (IL)

(21) Appl. No.: 19/333,811

(22) Filed: Sep. 19, 2025

Related U.S. Application Data
(60) Provisional application No. 63/697,186, filed on Sep. 20, 2024.

(51) Int. Cl. G06F 16/3329; G06F 16/335

(52) U.S. Cl. CPC G06F 16/3329; G06F 16/335

(57) ABSTRACT

The present disclosure relates to methods, systems, and apparatuses for generating analytics from interaction data using language models. An application executing on a computing system receives a query associated with a topic of interest and identifies a subset of interaction data from a larger collection of stored interactions based on metadata and high-level characterization related to the topic. Each interaction in the subset is processed by invoking a language model with the query and data corresponding to that interaction to generate an analytic output. The analytic outputs are aggregated across the subset to produce a quantified result for the topic of interest. The quantified result is provided to a user together with references to portions of the interaction data that support the analytic outputs, enabling validation of the analytics presented.

### CROSS-REFERENCE TO RELATED APPLICATIONS

This Application claims the benefit of and priority to U.S. Provisional Patent Application No. 63/697,186 , filed on Sep. 20, 2024, the entire contents of which are hereby incorporated by reference.

### BACKGROUND

### Field

Aspects of the present disclosure relate to artificial intelligence systems, and in particular, to techniques for generating analytics from interaction data using machine learning models.

### Description of Related Art

Organizations collect large volumes of interaction data from various sources, including voice calls, chat messages, emails, and social media posts. This interaction data often contains information that is useful for understanding customer behavior, monitoring service quality, and improving business operations.

Traditional approaches to analyzing interaction data may involve manual review by analysts or the use of keyword spotting and rules-based categorization. While such techniques can provide insights, they are often labor-intensive, time-consuming, and limited in their ability to capture the full context of interactions.

Advances in natural language processing have introduced automated tools that can process transcripts and messages at scale. For example, speech recognition systems can convert spoken audio into text, and text analytics systems can classify, cluster, or extract topics from large collections of interactions. Machine learning models have also been applied to identify sentiment, detect entities, or recognize predefined categories within text-based communication data.

Despite these developments, challenges remain in efficiently processing interaction data at scale, capturing nuanced behaviors across diverse communication channels, and delivering results in forms that are actionable for enterprise users. Systems that rely solely on manual analysis or rules-based processing may struggle to keep pace with growing data volumes and evolving customer expectations.

### SUMMARY

Certain aspects provide a computer-implemented method for generating analytics from interaction data using language models. The method comprises receiving, at an application executed by a computer system, a query associated with a topic of interest. The application identifies a subset of interaction data from a plurality of stored interactions based on metadata and other methods of unstructured data categorization, such as rule based categories (sometimes referred to as classifications) or keyword spotting, associated with the topic. Each interaction in the subset is analyzed by invoking a language model with the query and the interaction data to generate an analytic output. The analytic outputs are aggregated across the subset to produce a quantified result for the topic of interest, and the quantified result is presented to a user together with references to portions of the interaction data that support the analytic outputs.

Other aspects provide a computer-implemented method for generating analytics in which an application obtains a subset of interaction data from a plurality of stored interactions based on metadata and/or other methods of unstructured data categorization, such as rule based categories or keyword spotting, related to a topic of interest. For each interaction in the subset, the application invokes a language model with the query and the interaction data to generate a respective analytic output. The analytic outputs are aggregated across the subset to produce a quantified result for the topic, and the application links the quantified result to one or more references drawn from the subset of interaction data, such as transcript excerpts or timestamps. The quantified result and the references are then provided for presentation to a user, thereby enabling analytics that are both statistical in nature and grounded in verifiable evidence from the original interactions.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts an example interaction analytics generation system.

FIG. 2 depicts an example architecture of a language model engine.

FIG. 3 depicts an example architecture of an aggregation module.

FIG. 4 depicts an example results presentation environment.

FIG. 5 depicts an example flow diagram of a method for generating analytics from interaction data.

FIG. 6 depicts an example processing system with which aspects of the present disclosure can be performed.

FIG. 7 depicts an example system supporting a plurality of services.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for generating analytics from interaction data using artificial intelligence techniques. In some aspects described herein, an application executing on a computing system receives a query associated with a topic of interest, such as a request to determine reasons customers are canceling accounts. A subset of interaction data is identified from a larger collection of stored interactions based on metadata and/or other methods of unstructured data categorization, such as rule based high-level categories or simple keyword spotting, associated with the topic of interest. For each interaction in the subset, the application invokes a language model with the query and data corresponding to that interaction to generate an analytic output. The analytic outputs may include structured results such as a classification and supporting evidence extracted from the interaction. The analytic outputs are then aggregated across the subset to generate a quantified result for the topic of interest, such as a distribution of classifications with corresponding percentages. The quantified result is provided to a user together with references to portions of the interaction data that support the analytic outputs, enabling validation of the analytics presented.

In some embodiments, organizations rely on systems that process large volumes of customer interaction data including, but not limited to, transcripts of voice calls, chat conversations, emails, or social media messages, to generate business and behavioral analytics. To handle these unstructured data sources, systems may apply techniques including keyword detection, rules-based classification, clustering, or embedding-based retrieval combined with language models. These approaches can assist in identifying themes or extracting insights from interactions, but they often face challenges in scaling to enterprise-level datasets, maintaining accuracy across diverse communication channels, and producing outputs that are both quantifiable and verifiable for end users.

For example, traditional methods of categorizing customer interaction data may involve manual categorization of calls, extensive review of transcripts or listening of recordings, and manually synthesizing findings. This may delay surfacing actionable from large volumes of conversational data. As another example, analysts in training to perform this categorization may require training to become proficient in categorization, interpreting call data, and generating insights, which delays productivity and contribution. Still further, even after these insights are identified, manually producing outputs is time-consuming, consumes significant processing resources, and delays decision-making. Even if automated speech analytics techniques are applied for call identification, extensive manual effort may be involved to build and maintain a large comprehensive set of categories and sub-categories for the automated speech analytics, and such techniques may use keyword-based categorization which lacks adaptability and requires frequent manual updates to remain relevant.

One technique for enhancing insight extraction from customer interaction data is retrieval-augmented generation (RAG). RAG can be used to retrieve relevant transcripts or call segments from a large corpus of customer interactions. These relevant transcripts or call segments can be fed into generative models to summarize or answer prompts based on the retrieved transcripts or call segments.

Furthermore, while RAG introduces a promising approach to enhancing insight extraction from conversational data, it presents several practical and architectural limitations when applied to speech analytics workflows. First, RAG relies on a vector database to store and retrieve semantically indexed interactions. Building and maintaining this database is resource-intensive, requiring significant compute, storage, and engineering effort especially for large-scale or real-time environments. Second, to enable effective retrieval, transcripts may be segmented into discrete utterances or meaningful chunks. This process is complex, time-consuming, and costly, often requiring custom logic to preserve conversational context and speaker attribution. Third, to remain relevant and responsive to emerging customer issues, the vector database must be continuously updated with the latest interactions. This introduces operational overhead and latency, particularly in dynamic business environments. Fourth, RAG's performance is highly dependent on the quality of retrieval. Inaccurate or incomplete retrieval can lead to missed insights, incomplete summaries, or hallucinated outputs—where the generative model fabricates information not present in the source data.

The present disclosure introduces techniques that enable an application to take a question (for example, about customer interactions) and generate results that are both quantified and supported by evidence, with a much faster, more accurate and cost-effective approach than legacy methods. For example, a query may ask, “Why are customers canceling their accounts?” With this approach, the system leverages speech analytics, categorization application, keyword matching, text analytics, or the like, to identify the top interactions that are likely to include insight about cancellations. For example, these interactions may be identified from a large archive of call transcripts based on those interactions being tagged with metadata related to account cancellation, high-level categorizations related to account cancellation, or keyword tags related to cancellation. Each interaction in this subset may then be analyzed individually by a language model (e.g., a respective language model), which produces an analytic output that includes a short label for the reason (e.g., such as “price increase” or “moving”) together with a supporting quote drawn directly from the transcript. Once every call in the subset has been processed, the application can aggregate the outputs into a quantified result that shows the relative frequency of the different reasons across the dataset (e.g., 45% citing price, 22% citing relocation, and 10% citing competitor offers). In some aspects, the quantified result is presented along with the underlying transcript excerpts and timestamps, thereby not only providing the overall distribution but also enabling validation of the findings against the actual evidence in the interactions. In this way, the system transforms raw and unstructured communication data into actionable analytics that are both statistical in nature and grounded in verifiable portions of the source interactions.

In some embodiments, the techniques described herein provide a system that can analyze interaction data at scale while delivering outputs that are both quantified and verifiable. In one approach, an application executing on a computing system receives a query associated with a topic of interest and identifies a subset of interactions based on metadata that links the interactions to that topic, classifications/categorizations, or keyword matching. Each interaction in the subset may then be processed individually by a language model, which can generate an analytic output that may include a classification label and a supporting excerpt from the interaction. In some cases, the analytic outputs are aggregated to generate a quantified result, such as the relative frequency of classifications across the subset. The system further links the quantified result back to specific portions of the interaction data, thereby enabling the results to be validated against the original evidence. In this manner, the disclosed techniques provide a structured pipeline for transforming large amounts of raw, unstructured communication data into outputs that are statistical in nature and supported by references to the underlying interactions.

The disclosed techniques provide several technical solutions and advantages. For example, they enable the use of language models in a per-interaction analysis workflow, avoiding context window and latency limitations and the need for complex embedding-based retrieval pipelines or manual review by analysts. This approach allows the system to generate analytics that are fast, granular, scalable and cost-effective, while maintaining a direct connection to supporting evidence. By aggregating analytic outputs across subsets of interactions, the system produces quantified results that can be consumed by enterprise users in the form of charts, tables, or automated reports. Linking the results back to transcript excerpts or other data portions provides transparency and validation, improving trust in the generated analytics and reducing the impact of hallucinations by language models. In addition, the modular design of the system allows it to adapt across different communication channels, datasets, and deployment environments without requiring retraining of the underlying language model.

Thus, aspects described herein provide “reverse-RAG” interaction selection. Traditional RAG begins with a query and retrieves relevant documents from a vector database. Unlike traditional RAG, aspects described herein identify the most relevant interactions for a given high-level topic (e.g., customer churn, customer mentions, website issues, etc.) using speech and text analytics mechanisms. Then, aspects described herein identify the most relevant interactions for a given query by reference to metadata, high-level categorization, and/or keyword spotting relating to the topics, and process the most relevant interactions via language models (e.g., in parallel) to extract meaningful insights, trends, and summaries. This may, in some aspects, be performed in the absence of a vector database. By not implementing a vector database, transcript segmentation, or continuous re-indexing, aspects described herein avoid the cost, complexity, and latency associated with RAG. Aspects described herein also mitigate risks of retrieval inaccuracy and hallucinations by anchoring insights in pre-validated, high-relevance interactions (as determined according to metadata, high-level characterization, keyword spotting, or the like, related to the topics of the interactions).

### Example Interaction Analytics Generation System

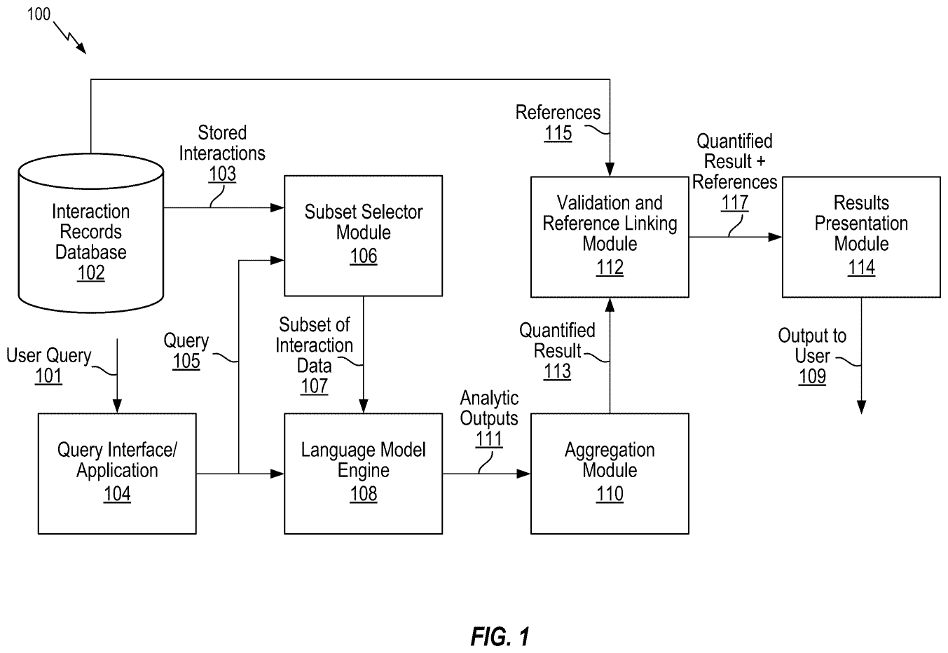

FIG. 1 depicts an example interaction analytics generation system 100. The interaction analytics generation system 100 is an example computing system configured to process large volumes of interaction data in response to a user query, generate analytic outputs for individual interactions using a language model, and aggregate the outputs into quantified results that are presented to the user together with supporting references. As depicted, system 100 includes query interface/application 104 for receiving user query 101, interaction records database 102 storing interaction transcripts and related metadata, and various processing modules for selecting relevant subsets of interaction data, invoking language model engine 108 to analyze those interactions, aggregating results, validating references, and presenting quantified outputs to the user. The interaction analytics generation system 100 may be implemented as part of system 700, for example, as one or more services 704.

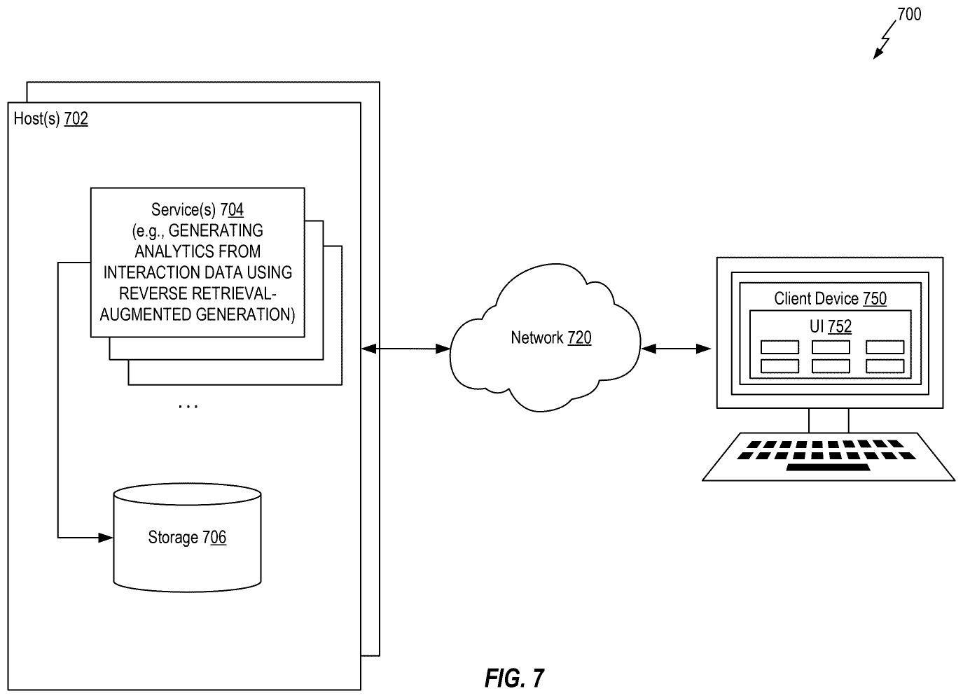

In some aspects, query interface/application 104 is operable to receive user query 101 and generate query 105 for downstream modules. In some examples, query interface/application 104 may be realized as part of service 704 hosted on one or more hosts 702, as shown in FIG. 7, with client device 750 providing user interface 752 for submitting queries via network 720. In other cases, query interface/application 104 may be integrated into an enterprise dashboard or web portal accessible through client device 750. User query 101 can be expressed in natural language, such as a typed or spoken request, or may be selected from predefined templates tailored to common analytics scenarios. By way of example, a customer service manager might type “Identify the main drivers of customer churn this quarter”, or a product manager might type “Identify the most common feature requests mentioned in support chats,” and these may be provided as user queries 101. In some examples, query interface/application 104 standardizes user query 101 into query 105, which may include additional contextual information such as query type, time range, or department-specific filters. Query 105 may then be transmitted both to subset selector module 106 and language model engine 108. By providing query 105 to multiple downstream modules, system 100 may enable the filtering of relevant interactions and the per-interaction analysis such that both are guided by the same user-specified intent, thereby maintaining consistency between subset selection and analytic generation.

In some embodiments, interaction records database 102 stores interaction data 103, which may encompass a wide variety of communication modalities. For example, interaction data 103 may include audio recordings of customer support calls that are transcribed into text, chat logs, email threads, survey responses, or social media comments. Each stored interaction may also be associated with metadata such as speaker identity, sentiment scores, detected entities, channel type, or processing timestamps. For instance, a call transcript may include metadata identifying the call center agent, customer region, and/or average handling time, and a classification tag such as “billing dispute”, which may be generated through a prior classification operation (e.g., using speech analytics or rules-based classification). This metadata may enable downstream components to more efficiently filter and organize interactions for analysis. In some aspects, interactions may additionally or alternatively be associated with keywords (or keywords may be identified in transcripts of such interactions), categorizations (for example, rules-based categorizations or classifications), or the like. Interaction records database 102 further supports retrieval of references 115 by validation and reference linking module 112, which may include locating exact transcript excerpts or time-aligned audio segments that support analytic outputs. In some implementations, interaction records database 102 may be realized as a distributed storage system, enabling scalability to millions of interactions per day, with indexing structures that allow efficient retrieval of both full transcripts and targeted metadata fields, categorizations, or keywords. As used herein, a classification may correspond to a category (e.g., such as a “price increase”, “moving”, “competitor offer”, etc. Thus, a classification label may represent a category assigned to an interaction). For example, “classification” may be used interchangeably with “category” or “categorization” herein.

In some embodiments, subset selector module 106 receives query 105 together with stored interactions 103 and is configured to identify subset of interaction data 107 relevant to the query 105 (e.g., relevant to a user's topic of interest). Subset selector module 106 can apply metadata-based filtering to reduce a large corpus of stored interactions 103 to a focused set of interactions 103 for deeper analysis. For example, if query 105 relates to account cancellation, subset selector module 106 may filter to select transcripts that have already been tagged by a speech analytics system with labels such as “cancellation,” “close account,” or “terminate service.” In another scenario, if query 105 seeks competitor mentions, subset selector module 106 may identify interactions containing keywords corresponding to competitor names or may leverage stored metadata fields that track third-party references. In addition to metadata, subset selector module 106 may use channel information, which refers to identifiers or attributes indicating the communication medium associated with an interaction (e.g., voice call, chat, email, social media message, etc.) to tailor the subset. For instance, when the query involves identifying customer sentiment, subset selector module 106 may focus on chat or email interactions where customers tend to provide more explicit written feedback. Additionally, or alternatively, subset selector module 106 may identify interactions according to categorizations (e.g., classifications) of the interactions. Additionally, or alternatively, subset selector module 106 may identify interactions according to keyword matching, such as by generating a keyword query and searching for interactions that include a word that matches the keyword query. The result of these operations is subset of interaction data 107, which balances computational efficiency with topical precision by narrowing a large number of records (e.g., millions of records) down to a smaller, highly relevant set. Furthermore, this selection of subset of interaction data 107 may be performed without a vector database, since the filtering relies on metadata, tags, classifications, or channel information rather than similarity searches over embeddings. Thus, aspects described herein sort and prioritize the dataset of records so that the most relevant interactions are shared with the language model engine 108, thereby reducing issues regarding context window size, latency, and hallucinations.

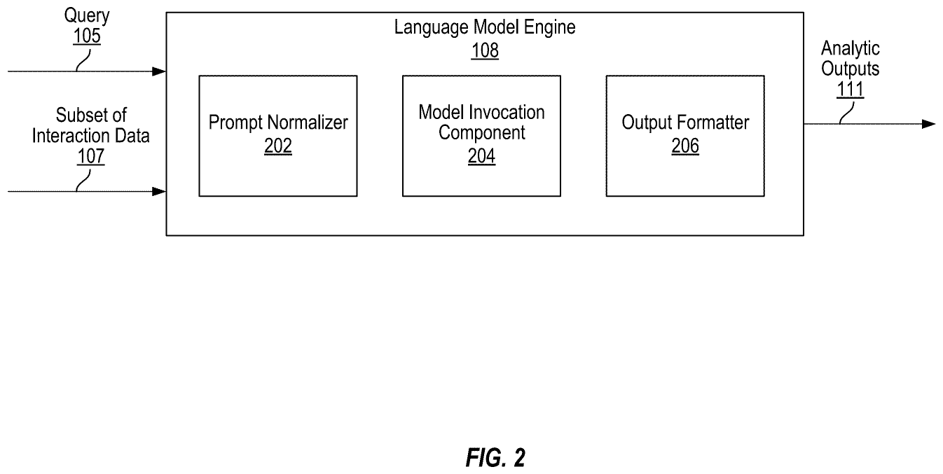

Language model engine 108 receives both query 105 and subset of interaction data 107 and processes each interaction within the subset independently to generate analytic outputs 111, as described in more detail in connection with FIG. 2. Each analytic output 111 may include a classification that responds to query 105, along with supporting evidence drawn directly from the processed interaction. For example, in the churn analysis case, a call transcript from subset of interaction data 107 may be processed to produce analytic output 111 labeled with a classification, such as “Reason: price increase” together with a supporting excerpt such as “My bill went up too much this month.” In another use case, if query 105 seeks compliance verification, language model engine 108 may generate an analytic output 111 labeled with a classification such as “Disclosure read: Yes” or “Disclosure read: No” along with a pointer to the relevant segment of the transcript. By generating analytic outputs 111 for each interaction, language model engine 108 produces results that are both granular and explainable. In some examples, language model engine 108 may include subcomponents such as a prompt normalizer that ensures consistent query phrasing, a model invocation component that executes inference requests, and an output formatter that structures results into standardized fields. Language model engine 108 may be implemented using large language models, multimodal language models, or other natural language processing architectures capable of handling diverse input formats and producing structured outputs.

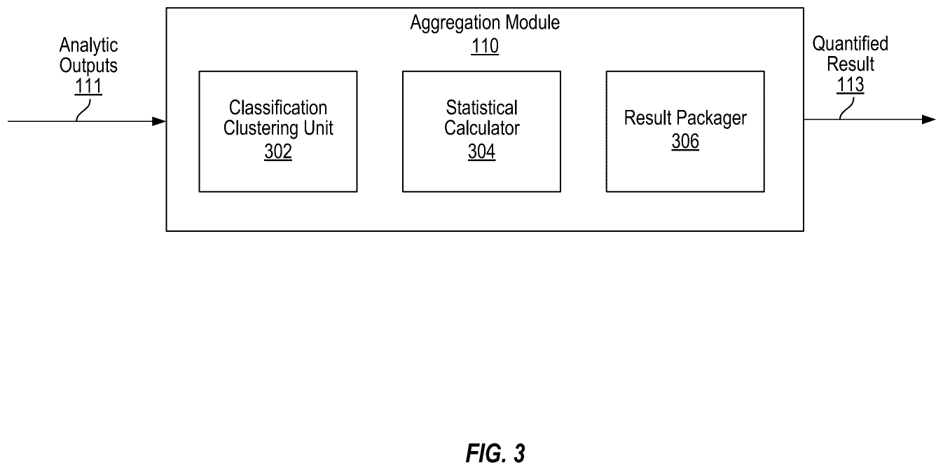

Interaction analytics generation system 100 may include an aggregation module 110, as described in more detail in connection with FIG. 3. In some embodiments, aggregation module 110 receives analytic outputs 111 generated for each interaction in subset of interaction data 107 and combines them to produce quantified result 113. In some implementations, aggregation module 110 groups analytic outputs 111 into classifications and computes distributions across those classifications, such as relative percentages, weighted averages, or simple frequency counts. For instance, when query 105 seeks reasons for account cancellation, aggregation module 110 may cluster outputs into classifications such as “price increase,” “moving,” or “competitor offer,” and determine that 45% of interactions cite price, 22% cite moving, and 10% cite competitor offers. In another scenario, when query 105 relates to competitor mentions, aggregation module 110 may compute tallies of brand references and output a ranked list of competitors most frequently discussed. Aggregation module 110 may also apply additional analytics such as temporal trend analysis (e.g., identifying shifts in reasons across different months), sentiment scoring across classifications (e.g., computing average sentiment polarity for interactions within each classification such as positive, neutral, or negative), or cross-channel comparisons (e.g., contrasting quantified results across communication channels such as voice calls, chat messages, emails, and social media posts). Quantified result 113 may thus represent a broad range of statistical views, depending on the user query 101, while preserving the linkage back to the underlying analytic outputs 111.

In some examples, quantified result 113 is provided to validation and reference linking module 112, which obtains references 115 from interaction records database 102 and associates them with the aggregated classifications. This linking enables quantified result 113 to be supported by direct evidence from the original interaction data. The direct evidence may include, for example, selections from transcripts of calls, written communications, or the like. For example, if 45% of cancellations are associated with “price increase,” validation and reference linking module 112 may retrieve representative transcript excerpts such as “My monthly bill went up too much” or “I can't afford this service after the latest price change”, along with their timestamps. These excerpts form references 115 that validate the aggregated outcome by grounding it in verbatim interaction content. In some cases, validation and reference linking module 112 may select a sample of references for each classification, prioritizing excerpts that best illustrate the classification. In other implementations, validation and reference linking module 112 may annotate each reference with metadata such as interaction ID, channel type, or confidence score, allowing users to further assess the reliability of the outputs. By attaching references 115 to quantified result 113, validation and reference linking module 112 provides transparency and ensures that analytics presented to users are not black-box results but are tied directly to evidence within stored interactions 103, thereby reducing the effect of or aiding in identification of potential hallucinations.

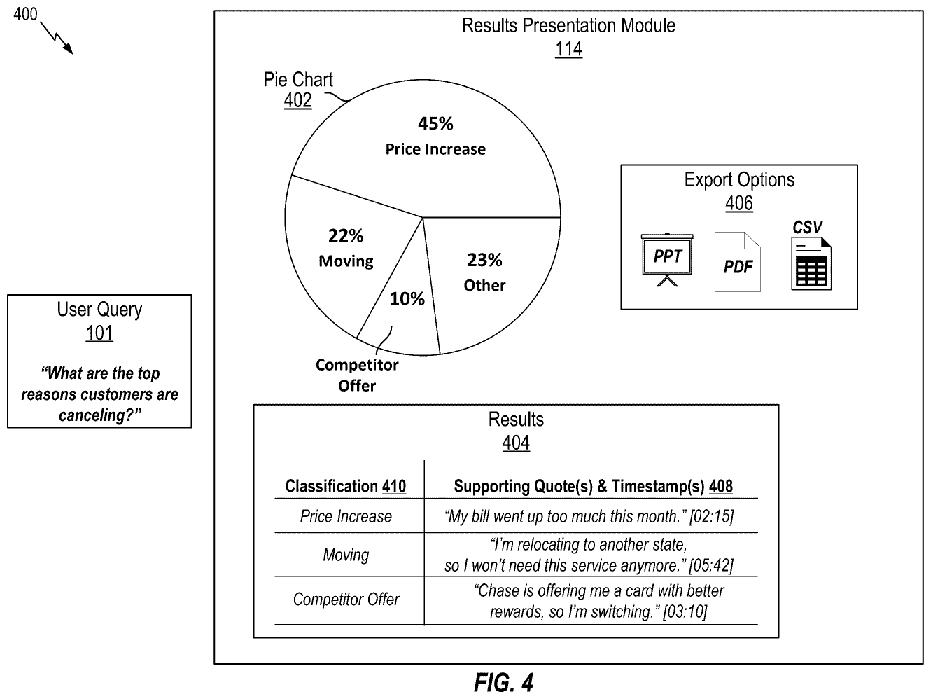

Validation and reference linking module 112 outputs quantified result and references 117 to results presentation module 114, which generates output to user 109 (e.g., in a form that is clear, actionable, and suitable for enterprise decision-making). Results presentation module 114 may provide a user interface that includes graphical visualizations such as pie charts, bar charts, or trend graphs illustrating the quantified result 113, along with a results table displaying representative references 117 tied to each classification, as described in more detail in connection with FIG. 4. For example, in a churn analysis query, results presentation module 114 may display a pie chart indicating the percentage distribution of cancellation reasons, while a results table shows transcript excerpts for each classification, such as “My bill went up too much this month” for the “price increase” classification. In some implementations, results presentation module 114 may include filtering tools or interactive controls that allow a user to drill down into specific classifications, view additional supporting references, or explore differences across time periods or communication channels. Results presentation module 114 may also support export options, such as generating a PowerPoint presentation, PDF report, or CSV file, so that quantified result and references 117 can be shared with other stakeholders or integrated into existing enterprise workflows. In some aspects, results presentation module 114 may further compute and display quantified financial impact measures, such as estimated cost savings, revenue generated, or customer experience (CX) improvements, automatically derived from the usage data and analytic insights.

In summary, interaction analytics generation system 100 provides a structured pipeline for converting raw and unstructured interaction data into quantified, evidence-backed insights. User query 101 is received by query interface/application 104, subset selector module 106 filters stored interactions 103 from interaction records database 102, language model engine 108 processes subset of interaction data 107 to generate analytic outputs 111, aggregation module 110 combines the outputs into quantified result 113, validation and reference linking module 112 attaches references 115 from stored interactions 103, and results presentation module 114 delivers quantified result and references 117 as output to user 109. This workflow enables scalable analysis across large-scale interactions (e.g., millions of interactions), provides transparent outputs grounded in original evidence, and supports enterprise use cases ranging from customer experience monitoring to compliance validation. In some cases, system 100 may be deployed across distributed computing environments (such as system 700), allowing multiple modules to execute in parallel to support near real-time analytics even as interaction volumes increase.

### Example Architecture of a Language Model Engine

FIG. 2 depicts an example architecture of language model engine 108. Language model engine 108 is configured to receive query 105 and subset of interaction data 107 as inputs, process each interaction in the subset with respect to the query, and generate analytic outputs 111. In the example embodiment shown in FIG. 2, language model engine 108 includes prompt normalizer 202, model invocation component 204, and output formatter 206, which together implement a structured pipeline for preparing model inputs, invoking one or more machine learning models, and formatting outputs into standardized analytic results.

In some aspects, prompt normalizer 202 is operable to process query 105 and subset of interaction data 107 received from query interface/application 104 and subset selector module 106, respectively (e.g., as illustrated in FIG. 1). Prompt normalizer 202 may standardize query 105 into a consistent template format, such that variations in phrasing or structure do not adversely affect downstream processing. For example, a user query 105 such as “Why are customers canceling their accounts?” may be normalized into a standardized request such as “Identify primary cancellation reasons with supporting excerpts.” Similarly, interaction transcripts drawn from subset of interaction data 107 may be pre-processed to remove artifacts such as speech recognition errors, disfluencies, or irrelevant system prompts. In some implementations, prompt normalizer 202 may append contextual instructions, such as requesting concise labels and verbatim supporting quotes, thereby guiding model invocation component 204 to produce outputs in a predictable structure.

In some embodiments, model invocation component 204 is operable to submit normalized prompts generated by prompt normalizer 202 to one or more underlying machine learning models. Model invocation component 204 may interact with a large language model hosted locally or accessed via an application programming interface (API). In some cases, model invocation component 204 may distribute prompts across multiple language model instances in parallel, such that each instance processes a distinct interaction within subset of interaction data 107 concurrently. This parallelization can support scalability when subset of interaction data 107 includes thousands or millions of records. Model invocation component 204 may also manage model configuration, such as selecting temperature or maximum output length, and may include logic for error handling, retries, or fallback models. By encapsulating these functions, model invocation component 204 may enable reliable and consistent operation of language model engine 108 across diverse queries and datasets.

In some examples, output formatter 206 is operable to transform responses received from model invocation component 204 into structured analytic outputs 111. Output formatter 206 may parse model-generated text into fields such as classification label, rationale, and supporting excerpt, which may enforce a standardized schema that is consumable by aggregation module 110 (e.g., as illustrated in FIG. 1). For instance, when language model engine 108 produces a response such as “Reason: price increase. Quote: ‘My bill went up too much this month.’”, output formatter 206 may extract “price increase” as the classification label and store the quote with an associated timestamp for evidence linkage. Output formatter 206 may further assign confidence scores, normalize classification labels across responses (e.g., treating “higher cost” and “price increase” as equivalent), or discard incomplete outputs that do not meet schema requirements. By ensuring that analytic outputs 111 are structured, consistent, and validated, output formatter 206 enables downstream modules to aggregate results effectively and attach supporting references for user consumption.

In summary, language model engine 108 provides a structured pipeline for generating analytic outputs 111 from query 105 and subset of interaction data 107. Prompt normalizer 202 prepares consistent prompts, model invocation component 204 executes inference across the subset of interactions, and output formatter 206 transforms responses into structured outputs. Together, these components allow language model engine 108 to produce reliable, explainable results that form the foundation for aggregation and evidence-linking operations in interaction analytics generation system 100.

### Example Architecture of an Aggregation Module

FIG. 3 depicts an example architecture of aggregation module 110. Aggregation module 110 is configured to receive analytic outputs 111 from language model engine 108 (e.g., as illustrated in FIG. 1) and generate quantified result 113 for consumption by validation and reference linking module 112. In the example embodiment shown in FIG. 3, aggregation module 110 includes classification clustering unit 302, statistical calculator 304, and result packager 306, which together provide functionality for grouping related analytic outputs, computing statistical distributions, and formatting results into a standardized structure suitable for downstream validation and presentation.

In some aspects, classification clustering unit 302 is operable to process analytic outputs 111 and group them into classifications based on common labels or semantic similarity (e.g., cosine similarity or other similarity metrics). For example, when analytic outputs 111 include responses such as “price increase,” “higher cost,” or “rate hike,” classification clustering unit 302 may cluster these under a single unified classification labeled “price increase.” Classification clustering unit 302 may rely on predefined taxonomies, rule-based mapping, or embedding-based similarity models to determine equivalence between terms. In one scenario, for a compliance query, classification clustering unit 302 may cluster outputs such as “disclosure read: Yes” and “disclosure read: Affirmative” into a single standardized classification. By consolidating variant expressions into coherent classifications, classification clustering unit 302 enables downstream statistical processing to reflect true distributional patterns rather than fragmented terminology, and eliminates the manual effort and delays typically involved to build and maintain such classifications.

In some embodiments, statistical calculator 304 is operable to compute one or more metrics across the classifications formed by classification clustering unit 302. Statistical calculator 304 may compute relative percentages, absolute frequencies, weighted averages, or temporal trends, depending on the nature of query 105 and analytic outputs 111. For instance, in a churn analysis scenario, statistical calculator 304 may determine that 45% of cancellations are attributed to price, 22% to moving, 10% to competitor offers, and 23% to other reasons. In another example, when query 105 relates to competitor mentions, statistical calculator 304 may compute ranked frequencies for different competitor names and optionally compare counts across communication channels. Statistical calculator 304 may also generate secondary measures such as sentiment averages per classification or confidence intervals to reflect variability in the underlying analytic outputs 111.

In some examples, result packager 306 is operable to assemble quantified result 113 in a structured format that can be consumed by validation and reference linking module 112 (e.g., as illustrated in FIG. 1). Result packager 306 may generate output data structures that include classification labels, corresponding statistical measures, and links back to underlying analytic outputs 111. These links may take various forms, such as direct pointers to the original interaction transcript, identifiers for specific documents, interaction IDs, or references to time-aligned audio segments. For example, quantified result 113 may include an entry for “price increase” with percentage value, absolute count, and pointers to supporting excerpts for downstream reference linking. Result packager 306 may further annotate results with metadata such as query identifier, processing timestamp, or data source channel. In some implementations, result packager 306 may generate multiple alternative representations of quantified result 113, such as tabular data for reporting, JavaScript Object Notation (JSON) structures for integration with external systems, or graphical summaries for direct rendering in results presentation module 114.

In summary, aggregation module 110 consolidates analytic outputs 111 into coherent classifications, computes statistical distributions across those classifications, and packages the results into quantified result 113 for downstream processing. Classification clustering unit 302 enables consistent grouping of related outputs, statistical calculator 304 provides robust quantitative measures, and result packager 306 formats the outputs into a consumable structure. Together, these components enable aggregation module 110 to transform raw per-interaction analytics into aggregated insights that capture trends, frequencies, and distributions across large datasets.

### Example Results Presentation Environment

FIG. 4 depicts an example results presentation environment 400. Results presentation environment 400 illustrates how results presentation module 114 (e.g., as shown in FIG. 1) may display (e.g., output to user 109) quantified result and references 117 to a user in response to user query 101. In the example embodiment shown in FIG. 4, results presentation module 114 may include pie chart 402 for visualizing the percentage distribution of analytic classifications, results table 404 for displaying supporting quotes and timestamps, and export options 406 for generating external files such as presentation decks, PDF reports, or CSV data tables. In some aspects, results presentation module 114 may render these visualizations and tables via UI 752 of client device 750 (as shown in FIG. 7), enabling a user to access quantified result and references 117 through a network-connected interface.

In some aspects, pie chart 402 is operable to display the relative proportions of classifications within quantified result 113. For example, in response to a churn analysis query, pie chart 402 may show that 45% of cancellations are due to price increase, 22% are due to moving, 10% are due to competitor offers, and 23% fall into an “other” classification. By way of example, pie chart 402 provides a visualization of the distribution, allowing decision makers to identify dominant themes or trends. In other cases, pie chart 402 may be replaced or supplemented by bar graphs, line graphs, or other visualization formats depending on the nature of user query 101 and the type of statistics computed by aggregation module 110.

In some embodiments, results table 404 is operable to display classifications 410 alongside supporting quotes and timestamps 408 drawn from stored interactions 103. For example, for the “price increase” classification 410, results table 404 may present the excerpt “My bill went up too much this month” with a timestamp of [02:15]. For the “moving” classification 410, it may display “I'm relocating to another state, so I won't need this service anymore” with a timestamp of [05:42]. For the “competitor offer” classification 410, it may show “Chase is offering me a card with better rewards, so I'm switching” with a timestamp of [03:10]. By grounding each classification 410 in verbatim quotes from stored interactions 103, results table 404 allows users to validate analytic findings and assess context directly.

In some examples, export options 406 are operable to generate external artifacts that include quantified result and references 117 (e.g., as shown in FIG. 1) in formats convenient for sharing and integration. For instance, export options 406 may allow a manager to generate a PowerPoint (PPT) presentation summarizing the distribution of classifications, a PDF report containing charts and supporting quotes, or a CSV file suitable for ingestion into business intelligence tools. Export options 406 may further support scheduling features or integration with enterprise reporting systems, enabling recurring generation of reports based on predefined queries. By providing multiple export modalities, results presentation module 114 enables analytic outputs to be readily incorporated into organizational workflows and decision-making processes.

In summary, results presentation environment 400 illustrates how results presentation module 114 surfaces quantified result and references 117 in a format that is accessible, transparent, and adaptable to enterprise needs. Pie chart 402 conveys high-level distributional patterns, results table 404 grounds those patterns in direct evidence from interaction transcripts, and export options 406 enable dissemination of the findings across different platforms.

### Example Method for Generating Analytics from Interaction Data

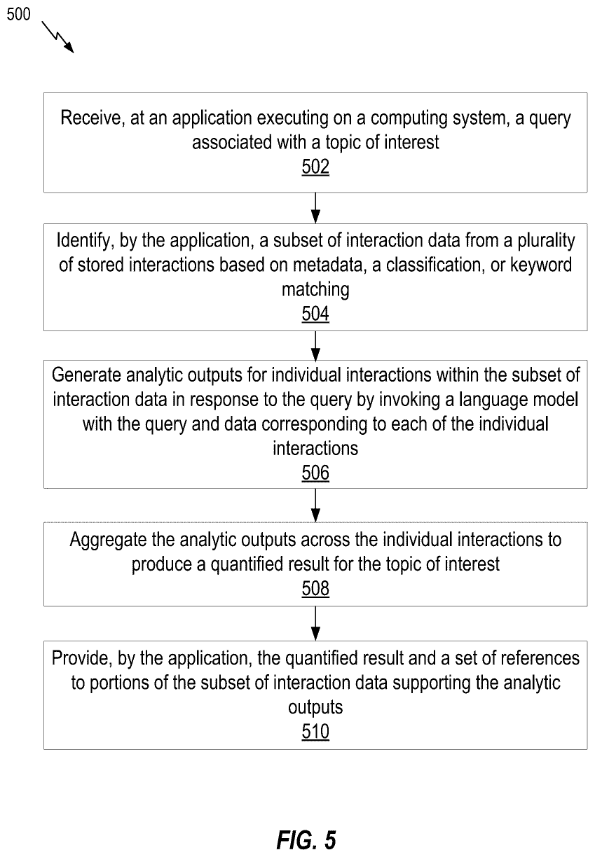

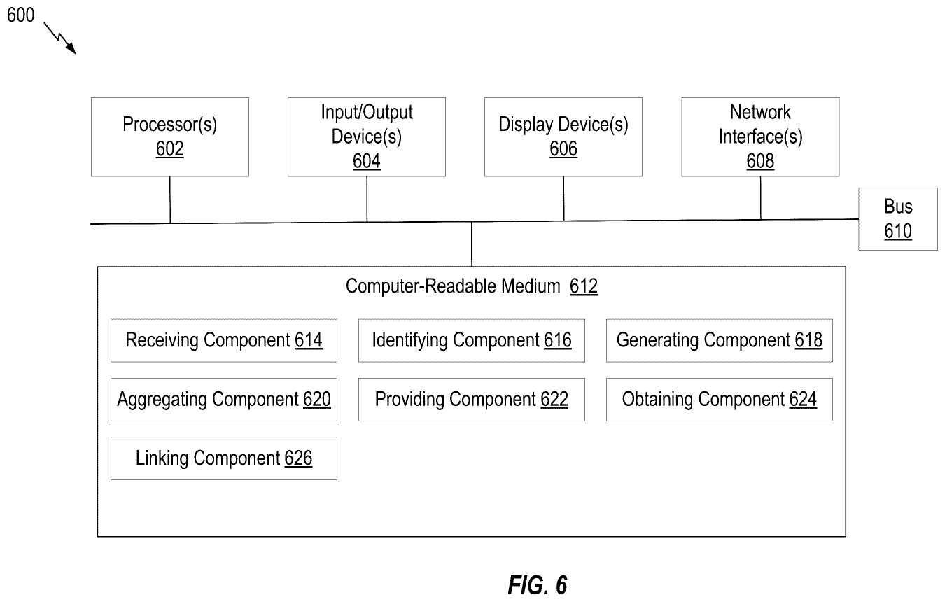

FIG. 5 depicts an example method 500 for generating analytics from interaction data using a language model. In one aspect, method 500 may be performed by a computing system such as interaction analytics generation system 100 of FIG. 1, by components including query interface/application 104, subset selector module 106, language model engine 108, aggregation module 110, validation and reference linking module 112, results presentation module 114, by service 704 of FIG. 7, and/or by processing system 600 of FIG. 6. As illustrated, method 500 has many variations, including those described below.

Method 500 starts at block 502 with receiving, at an application executing on a computing system, a query associated with a topic of interest. For example, as shown in FIG. 1, user query 101 may be entered into query interface/application 104. User query 101 may include a natural language request such as “Why are customers canceling their accounts?” or “Which competitors are most frequently mentioned?” In some aspects, query interface/application 104 standardizes user query 101 into query 105 and forwards it to both subset selector module 106 and language model engine 108 for downstream processing.

Method 500 continues to block 504 with identifying, by the application, a subset of interaction data from a plurality of stored interactions based on metadata associated with the topic of interest, a classification associated with the subset of interaction data, or a keyword matching operation. For example, as depicted in FIG. 1, subset selector module 106 receives stored interactions 103 from interaction records database 102 and applies metadata filters, such as speech analytics classifications, keywords, or channel identifiers, to identify subset of interaction data 107 relevant to query 105. In one case, if query 105 relates to account cancellations, subset selector module 106 may identify calls tagged with “cancellation” or “terminate.” In another case, if query 105 concerns competitor mentions, subset selector module 106 may select transcripts containing competitor brand names or metadata indicating competitor references.

Method 500 continues to block 506 with generating analytic outputs for individual interactions within the subset of interaction data in response to the query by invoking a language model with the query and data corresponding to each of the individual interactions. For example, as shown in FIG. 1, language model engine 108 receives query 105 and subset of interaction data 107 and produces analytic outputs 111. As further depicted in FIG. 2, language model engine 108 may include prompt normalizer 202 to prepare consistent prompts, model invocation component 204 to submit prompts to a large language model, and output formatter 206 to structure the model responses into analytic outputs 111. Each analytic output 111 may include a classification label (e.g., “Reason: price increase”) and a supporting transcript excerpt (e.g., “My bill went up too much this month”).

Method 500 continues to block 508 with aggregating the analytic outputs across the individual interactions to produce a quantified result for the topic of interest. For example, as shown in FIG. 1, aggregation module 110 receives analytic outputs 111 and generates quantified result 113 by clustering outputs into classifications and computing their relative frequencies. As illustrated in FIG. 3, classification clustering unit 302 may normalize variant labels, statistical calculator 304 may compute distributions (e.g., 45% citing price, 22% citing moving), and result packager 306 may assemble quantified result 113 in a format consumable by downstream modules.

Method 500 continues to block 510 with providing, by the application, the quantified result and a set of references to portions of the subset of interaction data supporting the analytic outputs. For example, as shown in FIG. 1, validation and reference linking module 112 links quantified result 113 to references 115 retrieved from interaction records database 102. These may include transcript excerpts and timestamps supporting each classification. As depicted in FIG. 4, results presentation module 114 may present quantified result and references 117 to user 109 using visualizations such as pie chart 402, results table 404, and export options 406. This ensures that users not only see aggregated statistics but also have access to the underlying evidence that supports the analytics.

In some embodiments, identifying the subset of interaction data comprises applying a speech analytics classification to the plurality of stored interactions. For example, as shown in FIG. 1, subset selector module 106 may filter stored interactions 103 in interaction records database 102 based on classifications generated by a speech analytics engine. A call transcript tagged with “cancellation” or “billing dispute” may thereby be selected into subset of interaction data 107 when query 105 relates to customer churn. In some embodiments, generating the analytic outputs comprises normalizing the query into a standardized single-interaction prompt prior to invoking the language model. For example, as shown in FIG. 2, prompt normalizer 202 of language model engine 108 may convert query 105 into a consistent template such as “Identify reason for cancellation with supporting excerpt”, ensuring that each interaction in subset of interaction data 107 is analyzed using the same structured prompt. This normalization allows model invocation component 204 to produce analytic outputs 111 in a predictable and comparable format across different interactions.

In some embodiments, aggregating the analytic outputs comprises clustering the analytic outputs into classifications and computing a percentage distribution for the classifications. For example, as shown in FIG. 3, classification clustering unit 302 of aggregation module 110 may group analytic outputs 111 with similar meanings under a unified classification, such as combining “higher cost” and “price increase” into a single label. Statistical calculator 304 may then compute a percentage distribution across these classifications, resulting in quantified result 113 showing relative proportions such as 45% citing price increase, 22% citing moving, and 10% citing competitor offers. In some embodiments, the set of references comprises one or more timestamped quotes extracted from the subset of interaction data. For example, as shown in FIG. 4, results table 404 may display transcript excerpts such as “My bill went up too much this month” with a timestamp of [02:15] or “I am relocating to another state” with a timestamp of [05:42], thereby grounding each classification of quantified result and references 117 in direct evidence from stored interactions 103.

In some embodiments, method 500 further comprises automatically generating a presentation file including the quantified result and the set of references. For example, as shown in FIG. 4, results presentation module 114 may use export options 406 to generate a PowerPoint presentation, PDF document, or CSV file that includes pie chart 402, results table 404, and supporting transcript excerpts. This allows quantified result and references 117 to be shared with other stakeholders or integrated into organizational reporting workflows. In some embodiments, invoking the language model comprises distributing the query to a plurality of language model agents, and wherein each of the plurality of language model agents is configured to process data corresponding to a distinct one of the individual interactions within the subset in parallel. For example, as shown in FIG. 2, model invocation component 204 may route prompts corresponding to different interactions to multiple instances of language model engine 108, enabling analytic outputs 111 for hundreds or thousands of interactions to be generated concurrently, thereby improving scalability and reducing overall processing latency.

In some embodiments, method 500 further comprises adapting a transcription engine based on user corrections or validation signals to improve transcription accuracy over time. For example, as shown in FIG. 1, interaction records database 102 may receive updated transcript text when a user validates or corrects a misrecognized phrase through validation and reference linking module 112. These corrections may be fed back to the transcription engine so that future audio-to-text conversions reduce similar errors, thereby enhancing the quality of stored interactions 103. In some embodiments, the subset of interaction data comprises interactions from multiple communication channels including voice calls, emails, chat messages, social media posts, or a combination thereof. For example, as shown in FIG. 1, stored interactions 103 in interaction records database 102 may span voice transcripts, email threads, customer support chat logs, and public social media comments, allowing subset selector module 106 to combine data from different channels when generating subset of interaction data 107 for analysis.

In summary, method 500 addresses technical challenges associated with analyzing large volumes of unstructured customer interaction data using language models. Method 500 introduces a structured workflow that includes receiving a user query, filtering a large archive of stored interactions into a relevant subset, generating analytic outputs for each interaction using a language model, aggregating those outputs into a quantified result, and linking the result back to supporting transcript excerpts or timestamps. This approach provides several technical benefits including improved scalability by parallelizing per-interaction analysis across thousands of records, enhanced transparency through direct linkage of aggregated results to verifiable portions of the source data, and increased accuracy by normalizing queries and clustering variant model outputs into standardized classifications. In addition, method 500 supports deployment across multiple communication channels, automated generation of presentation files, and adaptive feedback to transcription engines, enabling flexible customization and continual improvement over time. By combining per-interaction analysis with evidence-based aggregation, the system achieves a technical improvement over conventional keyword detection or rules-based classification pipelines, providing explainable, validated analytics that can be trusted in enterprise-scale decision-making environments.

Note that FIG. 5 is just one example of a method, and other methods including fewer, additional, or alternative operations are possible consistent with this disclosure.

FIG. 6 depicts an example processing system 600 configured to perform various aspects described herein, including, for example, method 500 as described above with respect to FIG. 5.

Processing system 600 is generally an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 600 includes one or more processors 602, one or more input/output devices 604, one or more display devices 606, one or more network interfaces 608 through which processing system 600 is connected to one or more networks (e.g., a local network, an intranet, the Internet, or any other group of processing systems communicatively connected to each other), and computer-readable medium 612. In the depicted example, the aforementioned components are coupled by a bus 610, which may generally be configured for data exchange amongst the components. Bus 610 may be representative of multiple buses, while only one is depicted for simplicity.

Processor(s) 602 are generally configured to retrieve and execute instructions stored in one or more memories, including local memories like computer-readable medium 612, as well as remote memories and data stores. Similarly, processor(s) 602 are configured to store application data residing in local memories like the computer-readable medium 612, as well as remote memories and data stores. More generally, bus 610 is configured to transmit programming instructions and application data among the processor(s) 602, display device(s) 606, network interface(s) 608, and/or computer-readable medium 612. In certain embodiments, processor(s) 602 are representative of a one or more central processing units (CPUs), graphics processing unit (GPUs), tensor processing unit (TPUs), accelerators, and other processing devices.

Input/output device(s) 604 may include any device, mechanism, system, interactive display, and/or various other hardware and software components for communicating information between processing system 600 and a user of processing system 600. For example, input/output device(s) 604 may include input hardware, such as a keyboard, touch screen, button, microphone, speaker, and/or other device for receiving inputs from the user and sending outputs to the user.

Display device(s) 606 may generally include any sort of device configured to display data, information, graphics, user interface elements, and the like to a user. For example, display device(s) 606 may include internal and external displays such as an internal display of a tablet computer or an external display for a server computer or a projector. Display device(s) 606 may further include displays for devices, such as augmented, virtual, and/or extended reality devices. In various embodiments, display device(s) 606 may be configured to display a graphical user interface.

Network interface(s) 608 provide processing system 600 with access to external networks and thereby to external processing systems. Network interface(s) 608 can generally be any hardware and/or software capable of transmitting and/or receiving data via a wired or wireless network connection. Accordingly, network interface(s) 608 can include a communication transceiver for sending and/or receiving any wired and/or wireless communication.

Computer-readable medium 612 may be a volatile memory, such as a random access memory (RAM), or a nonvolatile memory, such as nonvolatile random access memory (NVRAM), or the like. In this example, computer-readable medium 612 includes a receiving component 614, identifying component 616, generating component 618, aggregating component 620, providing component 622, obtaining component 624, and linking component 626.

In certain embodiments, receiving component 614 is configured to receive user query 101 associated with a topic of interest, as described above with respect to FIG. 1 and FIG. 5.

In certain embodiments, identifying component 616 is configured to identify subset of interaction data 107 from stored interactions 103 in interaction records database 102 based on metadata associated with the topic of interest, as described above with reference to FIG. 1 and FIG. 5.

In certain embodiments, generating component 618 is configured to invoke language model engine 108 with query 105 and data corresponding to interactions in subset of interaction data 107 to generate analytic outputs 111, as described above with reference to FIGS. 1, 2, and 5.

In certain embodiments, aggregating component 620 is configured to aggregate analytic outputs 111 across the interactions in subset of interaction data 107 to produce quantified result 113, as described above with reference to FIGS. 1, 3, and 5.

In certain embodiments, providing component 622 is configured to provide quantified result and references 117 as output to user 109, as described above with reference to FIGS. 1, 4, and 5.

In certain embodiments, obtaining component 624 is configured to obtain references 115 from stored interactions 103 in interaction records database 102, as described above with reference to FIGS. 1, 4, and 5.

In certain embodiments, linking component 626 is configured to link quantified result 113 with references 115 to generate quantified result and references 117, as described above with reference to FIGS. 1, 4, and 5.

Note that FIG. 6 is just one example of a processing system consistent with aspects described herein, and other processing systems having additional, alternative, or fewer components are possible consistent with this disclosure.

FIG. 7 depicts an example system 700 supporting a plurality of services 704 (e.g., software-defined services, which in some cases, may be cloud-native). As shown in FIG. 7, system 700 includes one or more client devices 750 (collectively referred to herein as “client devices 750”) and one or more hosts 702 (collectively referred to herein as “hosts 702”). A network 720 may provide connectivity between client device 750 and host 702. Network 720 may include, for example, a direct link, a local area network (LAN), a wide area network (WAN) (such as the Internet), another type of network, or a combination of one or more of these networks.

Host 702 may be geographically co-located servers on the same rack or on different racks in any arbitrary location in a data center. Host 702 may be implemented on a server-grade hardware platform. Host 702 or the hardware platform may include components of a computing device, such as one or more processors (e.g., central processing units (CPUs)), one or more memories (e.g., random access memory (RAM)), one or more network interfaces (e.g., physical network interfaces (PNICs)), storage 706, and/or other components, as described elsewhere herein. Storage 706 and other example components of an apparatus that may implement host 702 are described elsewhere herein.

Host 702 in system 700 may host a set of one or more services 704 (collectively referred to herein as “service(s) 704”). The service(s) 704 may be deployed using virtual machines (VMs) and/or container(s) implemented on host 702). For example, host 702 may implement a hypervisor (not shown) that abstracts processor, memory, storage, and networking resources of host 702's hardware platform). Generally, a service 704 is a loosely coupled and independently deployable service or software that, alone or in combination with one or more other services 704, may make up an application. Service(s) 704 may enable segmented, granular level functionalities within a larger system infrastructure. A reference to a single service 704 can encompass multiple services 704, unless context indicates otherwise. A service may include or be referred to as a microservice.

Client device 750 may include a user interface (UI) 752. UI 752 may be usable to communicate with service 704 via network 720. For example, communication between client devices 750 and a service 704 may be facilitated by one or more application programming interfaces (APIs). An API is a set of rules and protocols that allows different software applications to communicate and share data with each other. Non-exhaustive examples of client devices 750 may include a smartphone, a personal computer, a tablet, or a laptop computer. In some examples, service 704 may interact with another service, an application, a host, or the like, via network 720.

As shown in FIG. 7, in certain aspects, service 704 implements an interaction analytics generation service. The interaction analytics generation service may be a network-accessible microservice that performs functions such as receiving user queries 101, identifying subsets of interaction data 107 from stored interactions 103 based on metadata, invoking language model engine 108 to generate analytic outputs 111 for individual interactions, aggregating the analytic outputs to produce quantified result 113, and linking the quantified result to references 115 drawn from the underlying interaction data as described above with respect to FIG. 1. In this manner, service 704 provides evidence-backed analytics that transform large volumes of unstructured interactions into quantified and verifiable insights. A service 704, or a host 702 that implements a service 704, may be referred to as an apparatus.

Though FIG. 7 depicts host 702, storage 706, and client device 750 as single devices for ease of illustration, host 702, storage 706, and/or client device 750 may be embodied in a variety of forms. Further, though FIG. 7 depicts only one host 702 and one client device 750, other examples may include a different number of hosts 702 and/or client devices 750. Client devices 750 may use any combination of services 704 on any host 702 where services 704 are deployed.

### Example Clauses

Implementation examples are described in the following numbered clauses:

Clause 1: A method, comprising: receiving, at an application executing on a computing system, a query associated with a topic of interest; identifying, by the application, a subset of interaction data from a plurality of stored interactions based on at least one of metadata associated with the topic of interest, a classification associated with the subset of interaction data, or a keyword matching operation; generating analytic outputs for individual interactions within the subset of interaction data in response to the query by invoking a language model with the query and data corresponding to each of the individual interactions; aggregating the analytic outputs across the individual interactions to produce a quantified result for the topic of interest; and providing, by the application, the quantified result and a set of references to portions of the subset of interaction data supporting the analytic outputs.

Clause 2: The method of Clause 1, wherein the classification comprises a speech analytics classification of the plurality of stored interactions.

Clause 3: The method of any of Clauses 1-2, wherein generating the analytic outputs comprises normalizing the query into a standardized single-interaction prompt prior to invoking the language model.

Clause 4: The method of any of Clauses 1-3, wherein aggregating the analytic outputs comprises clustering the analytic outputs into classifications and computing a percentage distribution for the classifications.

Clause 5: The method of any one of Clauses 1-4, wherein the set of references comprises one or more timestamped quotes extracted from the subset of interaction data.

Clause 6: The method of any of Clauses 1-5, further comprising automatically generating a presentation file including the quantified result and the set of references.

Clause 7: The method of any of Clauses 1-6, wherein invoking the language model comprises distributing the query to a plurality of language model agents, and wherein each of the plurality of language model agents is configured to process data corresponding to a distinct one of the individual interactions within the subset in parallel.

Clause 8: The method of any of Clauses 1-7, further comprising adapting a transcription engine based on user corrections or validation signals to improve transcription accuracy over time.

Clause 9: The method of any of Clauses 1-8, wherein the subset of interaction data comprises interactions from multiple communication channels including voice calls, emails, chat messages, social media posts, or a combination thereof.

Clause 10: A method, comprising: obtaining, at an application executing on a computing system, a subset of interaction data from a plurality of stored interactions based on metadata associated with a topic of interest; for a given interaction of the subset of interaction data, invoking, by the application, a language model with a query associated with the topic of interest and with data corresponding to the given interaction to generate a respective analytic output; aggregating, by the application, the respective analytic outputs across the subset of interaction data to produce a quantified result for the topic of interest; linking, by the application, the quantified result to one or more references drawn from the subset of interaction data, wherein the one or more references include one or more transcript excerpts or timestamps; and providing, by the application, the quantified result and the one or more references for presentation to a user.

Clause 11: The method of Clause 10, wherein aggregating the respective analytic outputs comprises: clustering the respective analytic outputs into classifications; and computing a percentage distribution across the classifications.

Clause 12: A processing system, comprising: a memory comprising computer-executable instructions; and a processor configured to execute the computer-executable instructions and cause the processing system to perform a method in accordance with any one of Clauses 1-11.

Clause 13: A processing system, comprising means for performing a method in accordance with any one of Clauses 1-11.

Clause 14: A non-transitory computer-readable medium storing program code for causing a processing system to perform the steps of any one of Clauses 1-11.

Clause 15: A computer program product embodied on a computer-readable storage medium comprising code for performing a method in accordance with any one of Clauses 1-11.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or component(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method, comprising:
receiving, at an application executing on a computing system, a query associated with a topic of interest;
identifying, by the application, a subset of interaction data from a plurality of stored interactions based on at least one of:
metadata associated with the topic of interest,
a classification associated with the subset of interaction data, or
a keyword matching operation;
generating analytic outputs for individual interactions within the subset of interaction data in response to the query by invoking a language model with the query and data corresponding to each of the individual interactions;
aggregating the analytic outputs across the individual interactions to produce a quantified result for the topic of interest; and
providing, by the application, the quantified result and a set of references to portions of the subset of interaction data supporting the analytic outputs.

2. The method of claim 1, wherein the classification comprises a speech analytics classification of the plurality of stored interactions.

3. The method of claim 1, wherein generating the analytic outputs comprises normalizing the query into a standardized single-interaction prompt prior to invoking the language model.

4. The method of claim 1, wherein aggregating the analytic outputs comprises clustering the analytic outputs into classifications and computing a percentage distribution for the classifications.

5. The method of claim 1, wherein the set of references comprises one or more timestamped quotes extracted from the subset of interaction data.

6. The method of claim 1, further comprising automatically generating a presentation file including the quantified result and the set of references.

7. The method of claim 1, wherein invoking the language model comprises distributing the query to a plurality of language model agents, and wherein each of the plurality of language model agents is configured to process data corresponding to a distinct one of the individual interactions within the subset in parallel.

8. The method of claim 1, further comprising adapting a transcription engine based on user corrections or validation signals to improve transcription accuracy over time.

9. The method of claim 1, wherein the subset of interaction data comprises interactions from multiple communication channels including voice calls, emails, chat messages, social media posts, or a combination thereof.

10. A processing system, comprising:
one or more memories comprising computer-executable instructions; and
one or more processors configured to execute the computer-executable instructions and cause the processing system to:
receive, at an application executing on a computing system, a query associated with a topic of interest;
identify, by the application, a subset of interaction data from a plurality of stored interactions based on at least one of:
metadata associated with the topic of interest,
a classification associated with the subset of interaction data, or
a keyword matching operation;
generate analytic outputs for individual interactions within the subset of interaction data in response to the query by invoking a language model with the query and data corresponding to each of the individual interactions;
aggregate the analytic outputs across the individual interactions to produce a quantified result for the topic of interest; and
provide, by the application, the quantified result and a set of references to portions of the subset of interaction data supporting the analytic outputs.

11. The processing system of claim 10, wherein the classification comprises a speech analytics classification of the plurality of stored interactions.

12. The processing system of claim 10, wherein generating the analytic outputs comprises normalizing the query into a standardized single-interaction prompt prior to invoking the language model.

13. The processing system of claim 10, wherein aggregating the analytic outputs comprises clustering the analytic outputs into classifications and computing a percentage distribution for the classifications.

14. The processing system of claim 10, wherein the set of references comprises one or more timestamped quotes extracted from the subset of interaction data.

15. The processing system of claim 10, further comprising automatically generating a presentation file including the quantified result and the set of references.

16. The processing system of claim 10, wherein invoking the language model comprises distributing the query to a plurality of language model agents, and wherein each of the plurality of language model agents is configured to process data corresponding to a distinct one of the individual interactions within the subset in parallel.

17. The processing system of claim 10, further comprising adapting a transcription engine based on user corrections or validation signals to improve transcription accuracy over time.

18. The processing system of claim 10, wherein the subset of interaction data comprises interactions from multiple communication channels including voice calls, emails, chat messages, social media posts, or a combination thereof.

19. A method, comprising:
obtaining, at an application executing on a computing system, a subset of interaction data from a plurality of stored interactions based on metadata associated with a topic of interest;
for a given interaction of the subset of interaction data, invoking, by the application, a language model with a query associated with the topic of interest and with data corresponding to the given interaction to generate a respective analytic output;
aggregating, by the application, the respective analytic outputs across the subset of interaction data to produce a quantified result for the topic of interest;
linking, by the application, the quantified result to one or more references drawn from the subset of interaction data, wherein the one or more references include one or more transcript excerpts or timestamps; and
providing, by the application, the quantified result and the one or more references for presentation to a user.

20. The method of claim 19, wherein aggregating the respective analytic outputs comprises:
clustering the respective analytic outputs into classifications; and
computing a percentage distribution across the classifications.
